(19) United States
(12) Patent Application Publication
(10) Pub. No.: US 2013/0180498 A1
(43) Pub. Date: Jul. 18, 2013

(54) HIGH-PRESSURE SPARK AND STRATIFICATION IGNITION DEVICE FOR AN INTERNAL COMBUSTION ENGINE

(71) Applicant: Vianney RABHI, Lyon (FR)

(72) Inventor: Vianney RABHI, Lyon (FR)

(21) Appl. No.: 13/743,422

(22) Filed: Jan. 17, 2013

Related U.S. Application Data
(60) Provisional application No. 61/588,438, filed on Jan. 19, 2012.

(30) Foreign Application Priority Data
Jan. 18, 2012 (FR) 1250504

(51) Int. Cl. F02B 17/00

(52) U.S. Cl. CPC F02B 17/005
USPC 123/295

(57) ABSTRACT

The high-pressure spark and stratification ignition device (2) for an internal combustion engine (1) includes:
a stratification valve (20) closing the end of a stratification conduit (23), opening into the combustion chamber (9) of the internal combustion engine (1), and connecting the latter to a stratification chamber (24);
a spark plug (25) housed in the stratification valve (20);
a stratification actuator (27) responsible for lifting the stratification valve (20);
a stratification line (28) connecting the stratification chamber (24) to the outlet of a stratification compressor (29);
a stratification fuel injector (33); and
elements for recirculating previously cooled exhaust gases (40).

The present invention relates to a high-pressure spark and stratification ignition device for a reciprocating internal combustion engine with a highly diluted charge using means for recirculating previously cooled exhaust gases, known as “external cooled EGR” means.

The thermodynamic efficiency of reciprocating internal combustion heat engines depends on a number of factors including, firstly, the duration and phasing of the combustion intended to raise the temperature of the gases trapped in the combustion chamber after they have been compressed; secondly, the heat losses of the gases in contact with the internal walls of the engine; and, thirdly, the expansion rate of the gases, this expansion allowing the gases to exert a thrust on the piston of the engine so as to convert the heat energy released by the combustion into mechanical work.

However, the positive work produced by the thrust of the gases on the piston in their expansion is partially lost before it can be used at the output shaft of the heat engine. This is due to the negative, or resistive, work created by the pumping and transfer of the gases in the various intake and exhaust conduits and circuits of the heat engine, by the mechanical friction between the parts of the engine, and by the driving of the accessories and auxiliary equipment of the engine.

Thus, for a given quantity of fuel consumed, the efficiency of a reciprocating internal combustion heat engine rises with an increase in the positive work done on the piston of the engine by the gas compression-expansion cycle, and with a simultaneous decrease in the negative, or resistive, work produced by the entry and exit of the gases into and from the engine and the work produced by the mechanism of the engine and its accessories.

In order to convert the heat released by combustion into mechanical work as efficiently as possible, it is preferable for the fuel-air mixture introduced into the cylinder of the heat engine to burn rapidly, near the upper dead center of the piston of the engine, in other words at quasi-constant volume. This remains true as long as the gas temperature does not reach such a high level that the heat exchange between the gases and the internal walls of the combustion chamber of the engine becomes excessive. It also remains true as long as the pressure gradient created by the combustion does not result in excessive noise and is not caused by pinging.

Pinging is a spontaneous gas combustion which occurs after a certain period, under the combined effect of pressure and temperature, and which produces very large pressure waves which also tend to increase the heat exchange between the gases and the walls, notably by detaching the layer of insulating air covering the surfaces of the walls. Thus pinging is an undesirable phenomenon, which reduces the efficiency of the heat engine and which also tends to damage the internal members of the engine by thermal and mechanical overload.

Among the main methods of initiating combustion in the combustion chambers of reciprocating internal combustion heat engines, it is possible to distinguish between spark ignition, spontaneous ignition of the fuel on the injection front which is characteristic of diesel engines, and compression ignition using methods known by the abbreviations CAI (for Controlled Auto Ignition) or HCCI (for Homogeneous Charge Compression Ignition).

The combustion rate of controlled ignition engines depends primarily on the air/fuel ratio and the content of residual burnt gases in the fuel-air mixture introduced into the combustion chambers of the engines, on the distance that must be covered by the flame in order to burn all the mixture, and on the microturbulence within the mixture, the flame propagation speed being inversely proportional to this turbulence.

In the diesel cycle, the combustion rate is mainly determined by the diesel fuel injection quality, and by the cetane number of the diesel fuel. In CAI or HCCI, the compression rate, the initial temperature of the fuel-air mixture and its content of burnt gases, the characteristics of the fuel used and the homogeneity of the charge are factors which determine the initiation and rate of combustion. Regardless of the methods of initiating combustion, the rate of the combustion determines the rate of energy release, usually expressed in degrees of rotation of the crankshaft between the start and end of combustion, following a curve showing the cumulative fraction of burnt fuel as a function of the angular position of the crankshaft, one degree at a time.

Regardless of the combustion mode of the reciprocating internal combustion heat engines, in practice their efficiency is always higher when the heat exchange between the hot gases and the internal walls of the engines is minimal.

It should be noted that the heat exchange decreases if there is a small temperature difference between the gases and the walls, if there is little or no turbulent convection increasing the power of the exchange above that which is due to simple thermal conduction and radiation, and if the mass per unit volume of the gases is low.

In order to reduce the temperature difference between the hot gases and the internal walls of a reciprocating internal combustion heat engine, the temperature of the walls can be raised, and/or the temperature of the gases can be lowered. However, these two arrangements rapidly reach their limits in the improvement of the efficiency of controlled ignition reciprocating internal combustion heat engines.

This is because increasing the temperature of the internal walls of the combustion chamber of a reciprocating internal combustion heat engine has the disadvantage of reducing its filling capacity: the cold air or gas mixture coming into contact with the hot walls expands instantaneously, thereby reducing the volumetric efficiency of the engine in the intake phase, and consequently reducing its overall efficiency. Furthermore, the cold air or gas mixture overheated in this way makes the engine more liable to pinging, which must be compensated for, by providing a lower compression/expansion ratio and/or by providing delayed ignition, although both of these arrangements also reduce the efficiency of the engine. Various tests have been conducted in order to raise the temperature of the internal walls of the combustion chamber, as in the case of the so-called “adiabatic” engine with a ceramic combustion chamber and cylinders, made by Toyota. This engine offers very limited advantages in terms of efficiency, notably because, in the final analysis, the excessively high wall temperature tends to increase the heat loss of the gases on the walls, by comparison with other engines in which the cooler walls are more favorable to the maintenance and efficacy of the fine layer of insulating air which covers the internal walls of all reciprocating internal combustion heat engines. For these reasons, “adiabatic” engines have not progressed beyond the experimental stage.

As an alternative to raising the temperature of the internal walls of the combustion chamber, it is possible to reduce the temperature of the gases by diluting them either with added air or with exhaust gases which may or may not be previously cooled, these exhaust gases being obtained from the preceding cycle or cycles. By diluting the fuel-air charge introduced into the combustion chamber of a reciprocating internal combustion heat engine with a gas which does not participate in the combustion, it is possible to increase the total heat capacity of the charge in order to reduce its mean temperature for a given amount of energy released by the combustion.

Furthermore, regardless of the gas used, it contributes to the conversion of the heat released by combustion into mechanical work. However, in the case of controlled spark ignition engines, the propagation of the flame in a mixture which is excessively lean in fuel or lean in oxygen is either too slow or is impossible. This results in reduced thermodynamic efficiency, because the combustion takes place to an excessive degree at non-constant volume, as well as highly unstable combustion and ignition failures.

In order to dilute the charge introduced into the cylinder of a controlled ignition reciprocating internal combustion heat engine without suffering excessively from the last-mentioned drawbacks, there is an alternative approach in which the charge is stratified; in other words, a pocket of combustible fuel-air mixture centered around the ignition point of the engine is created, this pocket being surrounded with a mixture lean in fuel, highly diluted with cold air and/or exhaust gases in such proportions that the lean mixture is still mostly combustible.

This pocket is formed, notably, by the movements of the gases within the combustion chamber of the engine, these movements being caused, notably, by the geometry of the intake conduits of the engine and of the walls of the chamber, as well as by the dynamics and shape of the fuel jet injected directly into the chamber.

This method, known as the “stratified charge” method, usually requires the use of direct fuel injection and results in a charge which is rich in fuel around the ignition point, lean in fuel in the remaining area, and rich in oxygen throughout, giving rise to various problems in modern engines, notably in view of the regulations on pollution emissions.

This is because the charge stratified in this way must contain sufficient oxygen to ensure good initiation of combustion in the part of the charge around the ignition point, and sufficient oxygen in its remaining part to ensure good development of the combustion and its propagation throughout the volume of the combustion chamber of the engine, including the areas lean in fuel.

The excess oxygen which is characteristic of the operation of stratified charge engines according to the prior art makes it impossible to decrease nitrogen oxides by the three-way catalysis which is normally used for post-treatment of exhaust gases from controlled ignition engines.

In order to compensate for this problem which affects both stratified charge engines and engines with a lean mixture operating with excess oxygen, systems of post-treatment of nitrogen oxides in an oxidizing medium must be used, such as NOx traps or SCR (selective catalytic reduction), but these systems are particularly costly and sensitive to the quality and sulfur content of fuels, as well as being heavy and bulky.

It should be noted that the problems associated with stratified charges include the delayed direct injection of the fuel required for forming a fuel-rich pocket centered around the ignition point, this delayed injection resulting in a considerable production of fine particles which are health hazards.

Another problem associated with the stratified charge method is its operating range which is too limited at low loads, thus limiting its efficacy in reducing fuel consumption in currently used motor vehicles, particularly those having engines with a small cylinder capacity relative to their weight.

The latter problem which is related to the post-treatment of nitrogen oxides in an oxidizing medium can be avoided by providing compression ignition of the charge, as proposed in the CAI and HCCI methods, instead of spark ignition. These ignition methods lead to low-temperature combustion which produces practically no nitrogen oxides, and therefore enables the charge to be highly diluted with excess oxygen and/or the burnt gases initially produced in the preceding cycle or cycles, without the need to post-treat these oxides. Since it is not initiated by a spark, CAI or HCCI combustion avoids the constraints imposed by flame propagation from a single ignition point, as the combustion is initiated spontaneously at many points. However, CAI and HCCI are particularly sensitive to any variation in one or more of the parameters which enable it to operate, including, for example, the initial temperature of the charge, the effective compression rate to which it is subjected, the quality of fuel contained in it, and its content of burnt gases. CAI or HCCI combustion also generates a high pressure gradient, because it is extremely fast, and therefore produces disagreeable acoustic emissions.

Furthermore, like the stratified charge method, CAI and HCCI only operate at relatively low loads, thus limiting its efficacy in reducing fuel consumption in currently used motor vehicles, particularly those having engines with a small cylinder capacity relative to their weight.

An alternative to the use of a stratified charge or a homogeneous lean mixture with excess oxygen would be to replace the excess oxygen introduced into the charge with the recirculated burnt gases from the preceding cycle or cycles, using the method known to those skilled in the art as EGR (standing for exhaust gas recirculation). The problem with EGR is that, if cooling is not used (internal EGR), it increases the sensitivity of the heat engine to pinging, which adversely affects the efficiency of the engine, while if the EGR is previously cooled in a heat exchanger (external cooled EGR) the initiation and propagation of the flame become random and unstable. In all cases, it is difficult to combine EGR with stratification, where the lean areas would become incombustible.

As mentioned above, it is preferable for the fuel-air mixture introduced into the cylinder of any reciprocating internal combustion heat engine to burn rapidly, near the upper dead center of the piston of the engine, in other words at quasi-constant volume, and with the lowest possible heat loss at the walls.

In the case of controlled ignition engines, fast burning of the charge conflicts with the aim of diluting the charge with a gas which does not participate in its combustion, in order to reduce the heat losses on the internal walls of the engines, because a gas of this type tends to reduce the propagation speed of the flame in the volume containing the charge.

In order to restore a higher flame propagation speed, the internal turbulence of the fuel-air mixture can be increased, but this turbulence must not excessively increase the convective exchange, which magnifies the heat loss at the walls, thus counteracting the desired effect of charge dilution.

Another method of restoring the propagation speed may be to increase the compression rate of the internal combustion heat engine with the aim of increasing the density and enthalpy of the charge, both of which factors are favorable to the propagation speed.

However, this method is difficult to use in engines with a fixed compression rate, in which providing a markedly high compression rate would limit the torque at low engine speed, thus increasing the mean fuel consumption of the motor vehicles.

In this context, internal combustion heat engines with a variable compression rate have the decisive advantage of allowing their compression rate to be increased in a controlled way when the charge introduced into their cylinder(s) is highly diluted, particularly if the engines operate with partial charges, while allowing the rate to be reduced when the charge is higher and/or less diluted.

Accordingly, these variable compression engines allow the combustion of charges which are highly diluted with exhaust gases having low coefficients of cyclic variation, in other words small differences in combustion rate from one cycle to another and from one cylinder to another.

However, it should be noted that a high compression rate is unfavorable to the conversion of the macroscopic movements of the charge into fine turbulence at the upper dead center of the piston of the engine, this turbulence being favorable to the fast propagation of the flame in the fuel-air mixture.

In order to overcome this problem, a combustion chamber of what is known as the “squish” type can be provided, this chamber producing high turbulence when the piston reaches the vicinity of its upper dead center.

However, the problem with squish chambers is that the piston has to be brought very close to the cylinder head, entailing a risk of collision between the piston and the cylinder head, while the desired squish effect is provided only in the vicinity of the upper dead center, in other words relatively late with respect to the moment of the spark-initiated ignition of the charge.

Another drawback of squish chambers is that they strongly promote heat exchange between the gases and the internal walls of the combustion chamber.

In view of the above, it would clearly be advantageous to be able to provide fast combustion of stoichiometric charges highly diluted with external cooled EGR, in such a way that the polluting products could be post-treated with a three-way catalytic converter, without any excess turbulence which would counteract the reduction of the heat losses at the walls which is the desired effect of the dilution of the charge by the EGR. It would also be clearly advantageous to arrange for the combustion of the highly diluted stoichiometric charges over the widest possible operating range of the heat engine.

It is in order to meet this objective, to overcome the various aforementioned problems encountered in the prior art regarding internal combustion engines, and to enable these engines to be used in an economical, clean and fuel-saving manner that the high-pressure spark and stratification ignition device for a reciprocating internal combustion engine with a highly diluted charge proposes, according to the invention and according to a particular embodiment:
To create a pocket of stoichiometric fuel-air gas mixture forming what is called a “pilot” charge of small volume and mass, with a low content of EGR, which is centered, as far as possible, around the ignition point, is locally turbulent even in operation at a high compression rate, is produced at the most suitable moment during the compression phase, and is then ignited by an electric arc struck between the electrodes of a spark plug.

This has the purpose of:
Using the combustion of the pilot charge to provide, over a wide operating range of reciprocating internal combustion engines, ignition and combustion of a stoichiometric charge called the “main” charge, prepared in advance in the intake and/or compression phase and highly diluted with external cooled EGR supplied by an exhaust gas tapping device interacting with a cooler.

This has the effect of:
Generating a locally high turbulence in the pilot charge surrounding the ignition point and at the interface between the pilot charge and the main charge, so as to promote the rapid development of a wide flame front in the three-dimensional space of the combustion chamber, while retaining a globally moderate turbulence within the main charge in order to limit the convective heat exchange between the hot gases of the main charge and the internal wall of the chamber;

And has the following results:
Allowing the combustion of stoichiometric charges with a very high content of external cooled EGR;
Promoting fast, regular combustion of the stoichiometric charges close to the isochore;
Benefiting from the high energy efficiency of the stratified charge used in excess air, but by means of the stratification of stoichiometric charges which are highly diluted with external cooled EGR, so as to allow the post-treatment of pollutants produced by the combustion using a simple three-way catalytic converter and thus avoiding the use of costly, heavy and bulky NOx traps or selective catalytic reduction (SCR) devices;
Greatly extending the range of operating charges and positive effects on the efficiency of the stratification, from the lowest loads to relatively high or very high loads;
Significantly reducing the fuel consumption of all motor vehicles, including low powered vehicles and thermal-electric hybrid vehicles in which methods such as a reduction of cylinder capacity, known as “downsizing”, or the inactivation of cylinders have little or no positive effect on energy performance, the reduction in consumption being achieved, according to the invention, not by the repositioning of the engine operation in its speed-load ranges offering the best energy efficiency, but by increasing the energy efficiency over almost the whole operating range of the engine;
Making the high downsizing rates of engines less necessary for reducing the mean consumption of motor vehicles, these high downsizing rates significantly increasing the production cost of the vehicles, notably because of the high-performance supercharger systems which are required in these cases;
Allowing the production of engines having very low cylinder capacity with high energy efficiency, notably by reducing the unfavorable effect on their thermodynamic efficiency of the high surface/volume ratio of their combustion chambers which leads to high heat losses, this being achieved according to the invention by a significant reduction in the mean charge temperature of these engines due to the high dilution of the charge with external cooled EGR, this dilution naturally reducing the heat losses of these engines;
Enabling the engines to operate at a high compression rate in order to increase their thermodynamic efficiency, this being made possible, on the one hand, by a high resistance to pinging of the principal charge because of its high rate of dilution with external cooled EGR, and, on the other hand, by a high resistance to pinging of the pilot charge because of its proximity to the ignition point and its consequent fast combustion;
Naturally reducing the pumping losses of the engines, since the large-scale introduction of external cooled EGR into their cylinder(s) has the effect of increasing the intake pressure of the engines and thus opening their butterfly valves wider for a given operating point, this natural reduction of the pumping losses making it less necessary to use complex and costly devices for variable lifting of the intake valves to reduce these losses;
Avoiding the delayed gasoline injection during the compression phase that is characteristic of the operation of stratified charge engines operating in excess air, thereby avoiding the large-scale production of fine particles during combustion and thus avoiding the use of a costly and bulky particle filter for the post-treatment of these fine particles;
Enabling the charge to be stratified with a multi-point gasoline injection system as an alternative to the direct gasoline injection normally used to stratify the charge, the latter form of injection being more complicated and costly;
Providing freedom from the internal geometric constraints of the combustion chamber and of the intake conduit(s) and/or freedom from the constraints on the positioning and shape of the injector jet imposed by the use of stratified charges according to the prior art, these constraints arising from the need to provide a combustible pocket which is approximately centered around the ignition point and leading to various aerodynamic arrangements within the combustion chamber and within the intake conduit(s), mainly known under the terms “wall-guided”, “air-guided” and “spray-guided”, whereas these constraints are virtually dispensed with by using the ignition device according to the invention which offers greater freedom in the design of the chamber and conduits;
Allowing the stratification of charges highly diluted with external cooled EGR in engines of low unitary cylinder capacity, in which, firstly, the small bore is poorly compatible or even incompatible with direct injection which requires a minimum distance between the source of the injection jet and the walls of the combustion chamber, and, secondly, the mean charge currently used is potentially too high for sufficient benefit to be obtained from the advantages of the stratified charge operating with excess oxygen where operation is too limited at low loads, or in which, thirdly, the overall production cost of the stratified charge and of the associated post-treatment devices is too high relative to the category of vehicles for which these engines are intended;
Providing a fast temperature rise in the engines, notably because of the cooling of the recirculated exhaust gases via an air/water heat exchanger heated by the cooling water of the engines, this fast temperature rise making it possible, notably, to reduce the viscosity of the lubricating oil of the engines and the associated frictional losses, this resulting in a lower fuel consumption of the motor vehicles when they are used on short journeys beginning with a cold start of the engines, the fast temperature rise also having the advantage of improving the passenger comfort of the vehicles because of the faster temperature rise of the passenger compartments of the vehicles in the winter period;
Greatly reducing the consumption of gasoline and the associated carbon dioxide emissions of all motor vehicles at a limited production cost.

It should be noted that the ignition device according to the invention can also be used in non-stoichiometric engines operating with excess oxygen.

It should also be noted that the ignition device according to the invention can be applied to any reciprocating internal combustion engine with a fixed or variable compression rate and/or cylinder capacity, but that it offers more optimal operation when it is used in an engine having at least a variable compression rate, since this type of engine makes it possible to benefit from a high downsizing rate, owing to excellent efficiency at very high loads and owing to a distinctive capacity to handle these very high loads even without external cooled EGR using a temporarily low compression rate, and also to benefit from a very high rate of external cooled EGR at low and intermediate loads where combustion is made possible by a temporarily high compression rate. Without excluding any other application, the ignition device according to the invention is particularly suitable for reciprocating internal combustion engines used to power motor vehicles.

The high-pressure spark and stratification ignition device for an internal combustion engine according to the present invention comprises:
at least one low-lift stratification valve kept in contact with a seat by at least one spring, this valve closing the end of a stratification conduit and this end of the stratification conduit opening into the combustion chamber of the internal combustion engine, while the stratification conduit connects at least one stratification chamber to the combustion chamber;
at least one spark plug housed in the low-lift stratification valve, this spark plug having projecting electrodes positioned in the combustion chamber of the engine;
at least one stratification actuator controlled by the ECU computer of the internal combustion engine, this actuator being responsible for lifting the low-lift stratification valve from its seat, keeping it open, and returning it to its seat;
at least one stratification line connecting the stratification chamber to the outlet of a stratification compressor whose inlet is connected directly or indirectly to an atmospheric stratification air supply conduit, the line, the compressor, its inlet and outlet, and the supply conduit forming in combination an atmospheric air supply circuit of the stratification chamber, while the chamber itself forms an integral part of the circuit;
at least one stratification fuel injector controlled by the ECU computer of the internal combustion engine, the injector being capable of producing a jet of fuel within the atmospheric air supply circuit of the stratification chamber, at any point of the circuit;
at least means for recirculating previously cooled exhaust gases, called “external cooled EGR” means, controlled by the ECU computer of the internal combustion engine, these means making it possible to tap exhaust gases from the exhaust conduit of the engine and then to reintroduce the gases at the intake of the engine after the gases have been cooled by means of at least one cooler.

The high-pressure spark and stratification ignition device according to the present invention comprises a spark plug which is fixed to the stratification valve so as to be integral with the valve in its longitudinal translational movement.

The high-pressure spark and stratification ignition device according to the present invention comprises a spark plug which is fixed to the cylinder head of the internal combustion engine, the valve moving on its own with respect to the cylinder head and with respect to the spark plug.

The high-pressure spark and stratification ignition device according to the present invention comprises a low-lift stratification valve whose seat has a face oriented toward the outside of the combustion chamber of the internal combustion engine in such a way that the stratification actuator can only lift the valve from the seat by moving the valve away from the chamber.

The high-pressure spark and stratification ignition device according to the present invention comprises a low-lift stratification valve whose seat has a face oriented toward the inside of the combustion chamber of the internal combustion engine in such a way that the stratification actuator can only lift the valve from the seat by moving the valve toward the chamber.

The high-pressure spark and stratification ignition device according to the present invention comprises a stratification actuator which consists of a hydraulic stratification pump comprising a hydraulic stratification receiving chamber and a hydraulic stratification receiving piston, the piston being integral with the low-lift stratification valve or being connected thereto by hydraulic piston thrust means.

The high-pressure spark and stratification ignition device according to the present invention comprises a hydraulic stratification receiving chamber which is connected to a hydraulic stratification output chamber by at least one conduit, the hydraulic fluid contained in the hydraulic output chamber being pressurizable by a hydraulic stratification output piston when the latter compresses the fluid under the action of an electric stratification actuator.

The high-pressure spark and stratification ignition device according to the present invention comprises an electric stratification actuator which consists of at least one coil of conductive wire which attracts a magnetic core or blade when electric current flows through the coil, in such a way that the core or blade pushes the hydraulic stratification output piston via core or blade transmission means so that the piston compresses the hydraulic fluid contained in the hydraulic output chamber.

The high-pressure spark and stratification ignition device according to the present invention comprises an electric stratification actuator which consists of at least one stack of piezoelectric layers whose thickness varies when they are subjected to a flow of electric current, in such a way that the stack pushes the hydraulic stratification output piston via stack transmission means so that the piston compresses the hydraulic fluid contained in the hydraulic output chamber.

The high-pressure spark and stratification ignition device according to the present invention comprises core or blade transmission means consisting of a push rod for the hydraulic stratification output piston.

The high-pressure spark and stratification ignition device according to the present invention comprises a hydraulic stratification receiving chamber which is connected to a high-pressure hydraulic control fluid reservoir and/or to a low-pressure hydraulic control fluid reservoir by at least one high-pressure solenoid valve and/or by at least one low-pressure solenoid valve.

The high-pressure spark and stratification ignition device according to the present invention comprises a high-pressure hydraulic control fluid reservoir which is pressurized by a hydraulic control pump, this pump transferring a hydraulic fluid tapped from the low-pressure hydraulic control fluid reservoir to the high-pressure hydraulic control fluid reservoir.

The high-pressure spark and stratification ignition device according to the present invention comprises a hydraulic stratification receiving chamber which is connected directly or indirectly to the pressurized lubrication circuit of the internal combustion engine by a check valve, this valve allowing a hydraulic fluid contained in the circuit to flow from the circuit toward the chamber, but not in the reverse direction.

The high-pressure spark and stratification ignition device according to the present invention comprises a hydraulic stratification receiving chamber which is connected directly or indirectly to the pressurized lubrication circuit of the internal combustion engine by a pressure drop conduit, this conduit having a small cross section and/or a long length relative to its cross section, and/or having an internal shape which does not favor the establishment of a laminar flow, between the circuit and the chamber, of a hydraulic fluid contained in the circuit and/or the chamber.

The high-pressure spark and stratification ignition device according to the present invention comprises a stratification actuator which consists of at least one coil of conductive wire which is integral with the cylinder head of the internal combustion engine, the coil attracting a magnetic blade when electric current flows through the coil, in such a way that the blade pushes the low-lift stratification valve to which it is connected so as to cause its longitudinal translation.

The high-pressure spark and stratification ignition device according to the present invention comprises a stratification actuator which consists of at least one stack of piezoelectric layers whose thickness varies when they are subjected to a flow of electric current, in such a way that the stack pushes the low-lift stratification valve to which it is connected so as to cause its longitudinal translation.

The high-pressure spark and stratification ignition device according to the present invention comprises a stack of piezoelectric layers which is connected to the low-lift stratification valve by means of at least one lever which multiplies the displacement imparted by the stack to the valve.

The high-pressure spark and stratification ignition device according to the present invention comprises a stratification actuator which consists of a pneumatic stratification pump comprising a pneumatic stratification receiving chamber and a pneumatic stratification receiving piston, the piston being integral with the low-lift stratification valve or being connected thereto by pneumatic piston thrust means, while the pneumatic chamber can be connected to a high-pressure air chamber or to the open air or to a low-pressure air chamber by at least one solenoid valve.

The high-pressure spark and stratification ignition device according to the present invention comprises a stratification conduit, one end of which opens into the combustion chamber of the internal combustion engine and includes a stratification deflector.

The high-pressure spark and stratification ignition device according to the present invention comprises a stratification fuel injector which is connected to a reservoir of pressurized combustible gas.

The high-pressure spark and stratification ignition device according to the present invention comprises an atmospheric air supply circuit of the stratification chamber, including a homogenization circulator, the circulator being placed at any point of the circuit and agitating atmospheric air or a gas mixture contained in the circuit while causing the air or mixture to circulate through the circuit.

The high-pressure spark and stratification ignition device according to the present invention comprises an atmospheric air supply circuit of the stratification chamber, including an air-to-air heat exchanger for heating the supply circuit, which heats atmospheric air or a gas mixture contained in the circuit by extracting heat from the exhaust gases of the internal combustion engine, the air or gas mixture and the exhaust gases flowing simultaneously through the exchanger without mixing with one another.

The high-pressure spark and stratification ignition device according to the present invention comprises an atmospheric air supply circuit of the stratification chamber, including at least one electrical resistance for heating the supply circuit, which heats atmospheric air or a gas mixture contained in the circuit.

The high-pressure spark and stratification ignition device according to the present invention comprises an internal surface of the atmospheric air supply circuit of the stratification chamber which is wholly or partially covered with a thermal insulation material.

The high-pressure spark and stratification ignition device according to the present invention comprises an atmospheric air supply circuit of the stratification chamber, including an air-to-water heat exchanger for cooling the supply circuit, which cools atmospheric air or a gas mixture contained in the circuit by surrendering heat from the atmospheric air or gas mixture to a heat transfer fluid contained in the cooling circuit of the internal combustion engine.

The high-pressure spark and stratification ignition device according to the present invention comprises a stratification chamber including at least one inlet and/or at least one outlet which are tangential.

The high-pressure spark and stratification ignition device according to the present invention comprises an atmospheric air supply circuit of the stratification chamber, including at least one agitation chamber which imparts a turbulent motion to a gas mixture which is moving in the circuit, or which causes the gas mixture to undergo rapid pressure variations.

The high-pressure spark and stratification ignition device according to the present invention comprises a stratification line including at least one discharge valve which opens above a certain pressure level established in the line.

The high-pressure spark and stratification ignition device according to the present invention comprises a stratification line and/or an outlet of the stratification compressor and/or a stratification chamber including at least one discharge solenoid valve whose outlet opens at the intake of the internal combustion engine, or into a canister, or into a storage reservoir.

The high-pressure spark and stratification ignition device according to the present invention comprises an outlet of the stratification compressor which is connected to a pressure accumulator which stores atmospheric air or a gas mixture previously pressurized by the compressor, the accumulator also communicating directly or indirectly with the stratification line and the stratification chamber so as to keep the line and chamber under pressure.

The high-pressure spark and stratification ignition device according to the present invention comprises a low-lift stratification valve and a spark plug, which are contained in a single stratification cartridge screwed into the cylinder head of the internal combustion engine.

The high-pressure spark and stratification ignition device according to the present invention comprises a spark plug and a low-lift stratification valve, which are made in the same block of material.

The high-pressure spark and stratification ignition device according to the present invention comprises a spark plug which is mounted by screwing into the low-lift stratification valve.

The high-pressure spark and stratification ignition device according to the present invention comprises means for recirculating previously cooled exhaust gases, called “external cooled EGR” means, consisting of at least one proportional-lift EGR tapping valve or at least one proportional-rotation EGR tapping flap valve or at least one proportional-rotation EGR tapping sleeve valve positioned on the exhaust manifold of the internal combustion engine, the valve, flap valve or sleeve valve being capable of connecting the manifold to an external EGR supply conduit having an end, opposite the end opening into the manifold, which opens into the intake plenum of the internal combustion engine.

The high-pressure spark and stratification ignition device according to the present invention comprises a proportional-lift EGR tapping valve or a proportional-rotation EGR tapping flap valve or a proportional-rotation EGR tapping sleeve valve positioned on the exhaust manifold, which interacts with at least one proportional-lift counter-pressure exhaust valve or with a proportional-rotation counter-pressure exhaust flap valve or with a proportional-rotation counter-pressure sleeve valve incorporated in at least one of the outlets of the manifold.

The high-pressure spark and stratification ignition device according to the present invention comprises a stratification EGR cooler which is a high-temperature air-to-water heat exchanger in the external EGR supply conduit which cools the exhaust gases tapped from the exhaust conduit of the internal combustion engine, these exhaust gases surrendering some of their heat to a heat transfer fluid contained in the cooling circuit of the internal combustion engine.

The high-pressure spark and stratification ignition device according to the present invention comprises a stratification EGR cooler which is a low-temperature air-to-water heat exchanger in the external EGR supply conduit which cools the exhaust gases tapped from the exhaust conduit of the internal combustion engine, these exhaust gases surrendering some of their heat to a heat transfer fluid contained in an independent cold water circuit incorporated in the internal combustion engine.

The high-pressure spark and stratification ignition device according to the present invention comprises a stratification line and/or a stratification compressor outlet and/or a stratification chamber which includes at least one valve or injector for a fuel-air mixture for keeping a catalytic converter at a given temperature, the valve or injector being capable of transferring a fuel-air mixture from the line, from the outlet or from the chamber toward an exhaust conduit of the internal combustion engine, the mixture being introduced by the valve or injector into the conduit at any point of the conduit located between the exhaust valve of the engine and the catalytic converter for post-treating the pollutants from the engine.

The high-pressure spark and stratification ignition device according to the present invention comprises a fuel-air mixture valve or injector for keeping a catalytic converter at a given temperature, which is connected to an exhaust conduit of the internal combustion engine by a fuel-air mixture conduit for keeping a catalytic converter at a given temperature.

The following description which refers to the appended drawings, provided by way of non-limiting example, will assist in the understanding of the invention, its characteristics and the advantages which it can provide.

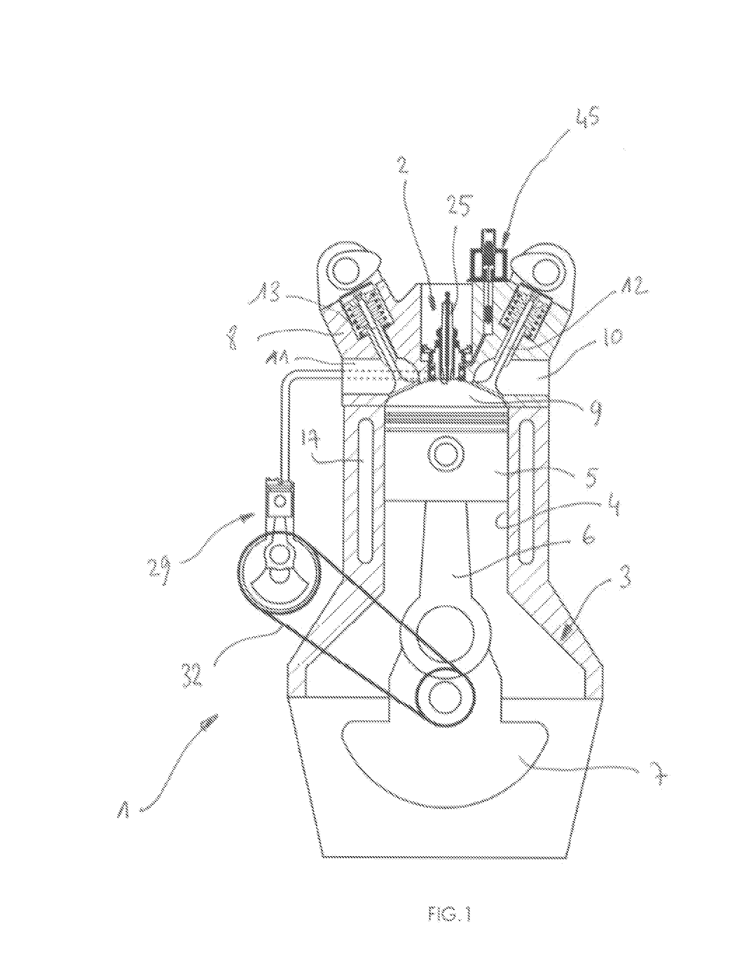

FIG. 1 is a schematic sectional view of the high-pressure spark and stratification ignition device according to the invention mounted on a reciprocating internal combustion heat engine.

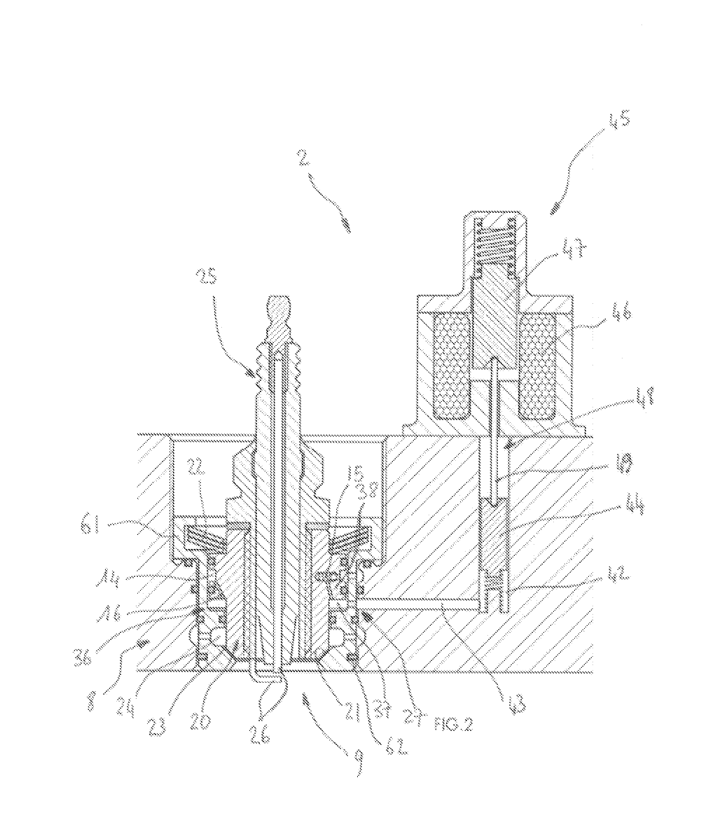

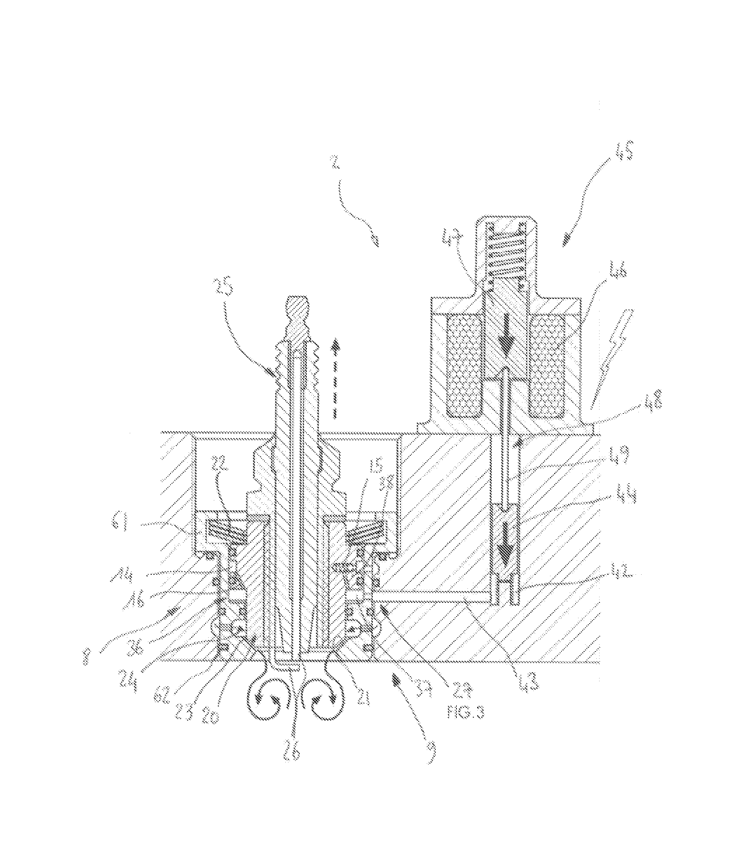

FIGS. 2 and 3 are schematic sectional views of the high-pressure spark and stratification ignition device according to the invention, with the stratification valve in the closed position and then the open position respectively, the seat of the valve being oriented toward the outside of the combustion chamber of the internal combustion engine and the valve being liftable from the seat by a hydraulic stratification pump pressurized by an output piston moved by an electric solenoid actuator.

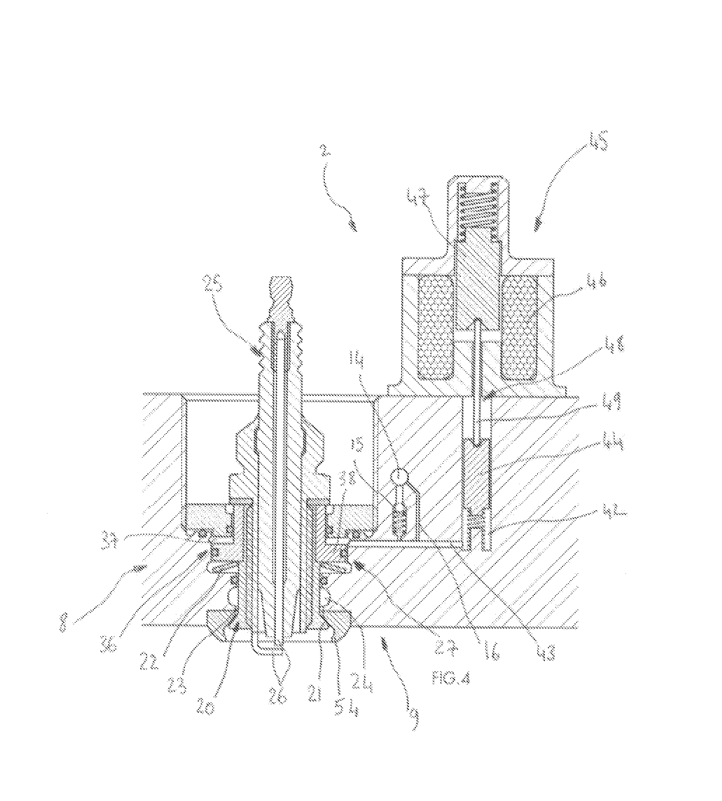

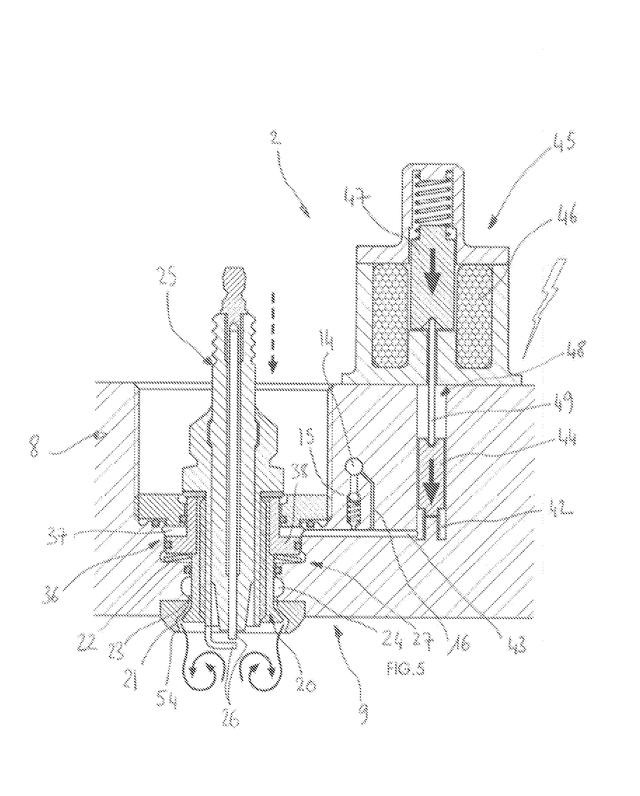

FIGS. 4 and 5 are schematic sectional views of the high-pressure spark and stratification ignition device according to the invention, with the stratification valve in the closed position and then the open position respectively, the seat of the valve being oriented toward the inside of the combustion chamber of the internal combustion engine and the valve being liftable from the seat by a hydraulic stratification pump pressurized by an output piston moved by an electric solenoid actuator.

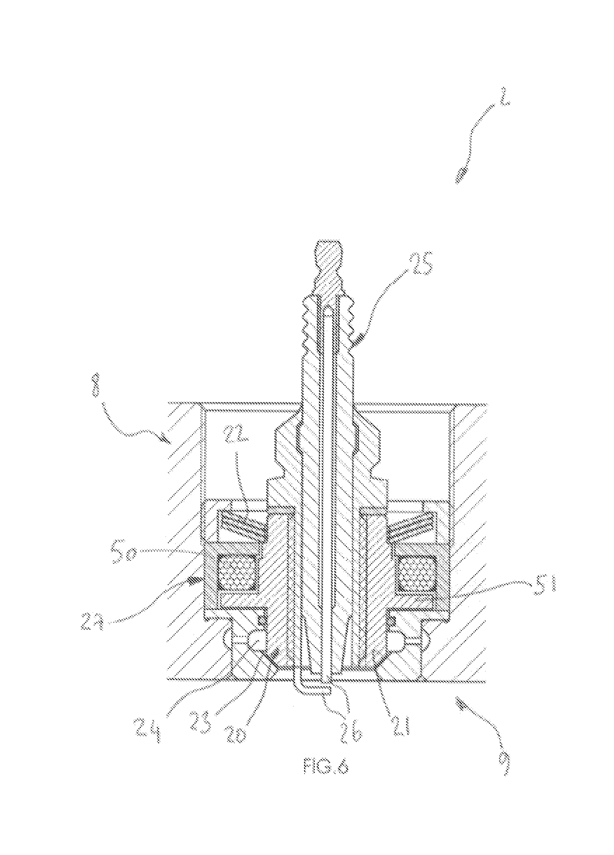

FIG. 6 is a schematic sectional view of the high-pressure spark and stratification ignition device according to the invention in which the stratification valve can be lifted from its seat by a coil of conductive wire integral with the cylinder head of the internal combustion engine, the coil being capable of attracting a magnetic blade integral with the valve.

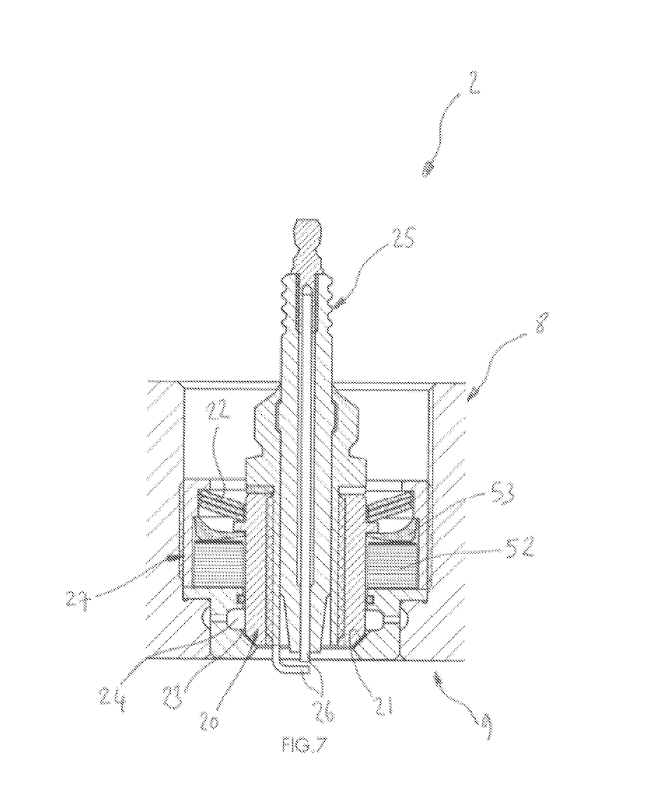

FIG. 7 is a schematic sectional view of the high-pressure spark and stratification ignition device according to the invention in which the stratification valve can be lifted from its seat by a stack of piezoelectric layers acting through at least one lever which multiplies the displacement imparted by the stack to the valve.

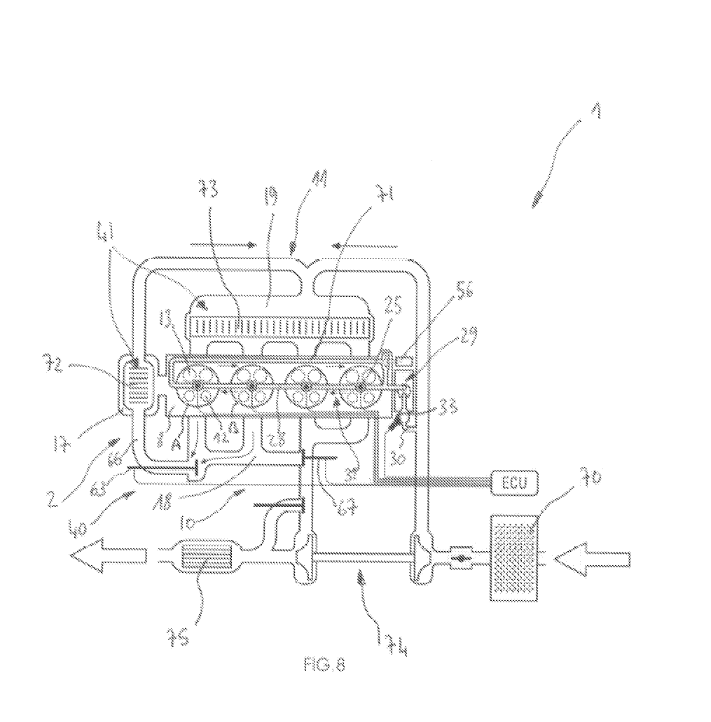

FIG. 8 shows a first variant arrangement of the different components of the high-pressure spark and stratification ignition device according to the invention, the device being applied to a reciprocating internal combustion heat engine with four cylinders in line supercharged by a turbocharger, this variant including, notably, a homogenization circulator, a proportional-lift EGR tapping valve and a proportional-lift counter-pressure exhaust valve.

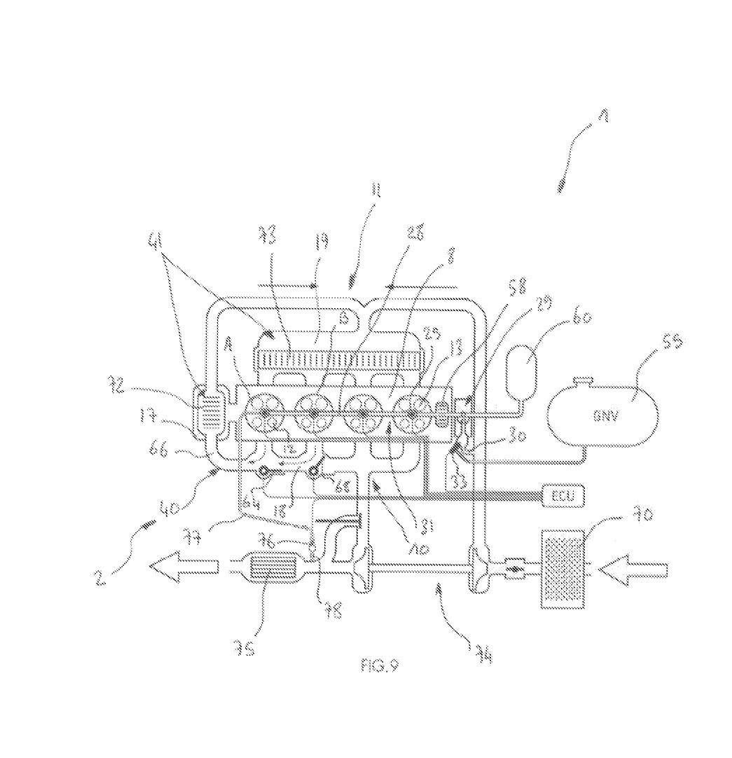

FIG. 9 shows a second variant arrangement of the different components of the high-pressure spark and stratification ignition device according to the invention, the device being applied to a reciprocating internal combustion heat engine with four cylinders in line supercharged by a turbocharger, this variant including, notably, a pressure accumulator which stores atmospheric air or the gas mixture pressurized by the stratification compressor, a stratification fuel injector connected to a pressurized combustible gas reservoir, a proportional-lift EGR tapping valve and a proportional-lift counter-pressure exhaust flap valve.

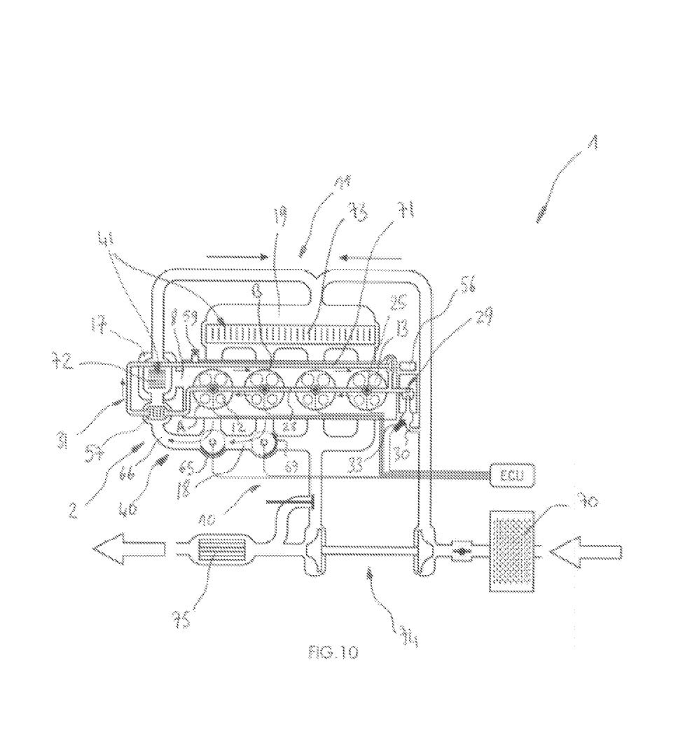

FIG. 10 shows a third variant arrangement of the different components of the high-pressure spark and stratification ignition device according to the invention, the device being applied to a reciprocating internal combustion heat engine with four cylinders in line supercharged by a turbocharger, this variant including, notably, an air-to-air heat exchanger for heating the atmospheric air supply circuit, a proportional-lift EGR sleeve valve and a proportional-lift counter-pressure exhaust sleeve valve.

### DESCRIPTION OF THE INVENTION

FIG. 1 shows an internal combustion heat engine 1 including a high-pressure spark and stratification ignition device 2 according to the present invention. The internal combustion engine 1 includes an engine block or cylinder housing 3 which comprises at least one combustion cylinder 4 which is closed by a cylinder head 8 and in which a combustion piston 5 moves.

The combustion piston 5 is mounted on a rod 6 which is connected to a crankshaft 7 in order to transmit the movement of the combustion piston 5 within the combustion cylinder 4.

The cylinder head 8 of the internal combustion engine 1 has a combustion chamber 9 into which there open, on the one hand, an intake conduit 11 communicating via an intake valve 13 with an intake plenum 19, and, on the other hand, an exhaust conduit 10 communicating via an exhaust valve 12 with an exhaust manifold 18 and with a catalytic converter 75 for post-treatment of the pollutants.

The internal combustion engine 1 further comprises a cooling circuit 17.

FIGS. 1 to 10 show the high-pressure spark and stratification ignition device 2 according to the present invention.

The high-pressure spark and stratification ignition device 2 comprises at least one low-lift stratification valve 20 held in contact with a seat 21 by at least one spring 22.

The low-lift stratification valve 20 is designed to close the end of a stratification conduit 23. The end of the stratification conduit 23 is designed to open into the combustion chamber 9 of the internal combustion engine 1, while the stratification conduit 23 connects at least one stratification chamber 24 to the combustion chamber 9.

The spring 22 may act directly or indirectly by means of a solid or a fluid on the low-lift stratification valve 20, and this spring may be mechanical and made of any material, may operate by flexion, torsion or traction, and may be, for example, a Belleville spring washer, a helical or leaf spring, a corrugated spring washer or a spring washer having any other geometry, and may be of any type known to those skilled in the art.

In a particular embodiment, the spring 22 may also be pneumatic, using the properties of compressibility of a gas, or hydraulic, using the properties of compressibility of a fluid.

The high-pressure spark and stratification ignition device 2 comprises at least one spark plug 25 housed in the low-lift stratification valve 20.

The spark plug 25 is fixed to the low-lift stratification valve 20 so as to be integral with the valve in its longitudinal translational movement.

In another embodiment, the spark plug 25 may be fixed to the cylinder head 8 of the internal combustion engine 1, the low-lift stratification valve 20 then moving on its own with respect to the cylinder head and with respect to the spark plug.

The spark plug 25 has projecting electrodes 26 which are positioned in the combustion chamber 9 of the internal combustion engine.

In a particular embodiment, the spark plug 25 may be identical or similar to those fitted in controlled ignition internal combustion engines of types known to those skilled in the art.

The high-pressure spark and stratification ignition device 2 comprises at least one stratification actuator 27 controlled by an ECU computer incorporated in the internal combustion engine 1.

The stratification actuator 27 is responsible for lifting the low-lift stratification valve 20 from its seat, keeping it open, and returning it to its seat 21.

The high-pressure spark and stratification ignition device 2 comprises at least one stratification line 28 connecting the stratification chamber 24 to the outlet of a stratification compressor 29 whose inlet is connected directly or indirectly to a stratification atmospheric air supply conduit 30.

The stratification line 28, the stratification compressor 29, its inlet and outlet, and the supply conduit 30 form, in combination, an atmospheric air supply circuit 31 of the stratification chamber 24, the chamber itself forming an integral part of the circuit.

It should be noted that the stratification compressor 29 may be of any type known to those skilled in the art, that the compressor may have a fixed or variable cylinder capacity, may be of the type using one or more pistons, blades, or screws with or without lubrication, may be single-stage, two-stage or multiple-stage, and may or may not have intermediate cooling.

Depending on the chosen embodiment of the high-pressure spark and stratification ignition device 2 according to the invention, the stratification compressor 29 may, notably, be fixed directly or indirectly to the internal combustion engine 1 and may be driven mechanically by a crankshaft 7 incorporated in the engine, using at least one pinion or at least one chain or at least one belt 32 via a transmission having a fixed or variable ratio, or electrically by an alternator driven by the crankshaft which generates the current required by an electric motor driving the compressor, in which case the electrical energy generated by the alternator may or may not be stored in advance in a battery.

The high-pressure spark and stratification ignition device 2 comprises at least one stratification fuel injector 33 controlled by the ECU computer of the internal combustion engine 1.

The stratification fuel injector 33 can produce a jet of fuel within the atmospheric air supply circuit 31 of the stratification chamber 24, at any point of the circuit.

The stratification fuel injector 33 may inject a liquid or gas fuel and may be of a single-stage or multiple-stage type, of the solenoid or piezoelectric type, or, in general, of any type known to those skilled in the art.

The high-pressure spark and stratification ignition device 2 comprises at least means for recirculating previously cooled exhaust gases 40, called “external cooled EGR” means, controlled by the ECU computer, these previously cooled exhaust gas recirculation means 40 making it possible to tap exhaust gases from the exhaust conduit 10 of the internal combustion engine 1 and then to reintroduce the gases at the intake of the engine after the gases have been cooled by means of at least one cooler 41.

The high-pressure spark and stratification ignition device 2 comprises a low-lift stratification valve 20 whose seat 21 has a face which is oriented toward the outside of the combustion chamber 9 of the internal combustion engine 1 in such a way that the stratification actuator 27 can only lift the valve from the seat by moving the valve away from the chamber (FIGS. 2 and 3).

In another embodiment, the high-pressure spark and stratification ignition device 2 comprises a low-lift stratification valve 20 whose seat 21 has a face which is oriented toward the inside of the combustion chamber 9 of the internal combustion engine 1 in such a way that the stratification actuator 27 can only lift the valve from the seat by moving the valve toward the chamber (FIGS. 4 and 5).

It should be noted that the stratification actuator 27 consists of a hydraulic stratification pump 36 comprising a hydraulic stratification receiving chamber 37 and a hydraulic stratification receiving piston 38, the piston being integral with the low-lift stratification valve 20 or being connected thereto by hydraulic piston thrust means.

The hydraulic stratification receiving piston 38 may have joints for forming a seal with a cylinder with which it interacts.

The hydraulic stratification receiving chamber 37 is connected to a hydraulic stratification output chamber 42 by at least one conduit 43, the hydraulic fluid contained in the hydraulic output chamber 42 being pressurizable by a hydraulic stratification output piston 44 when the latter compresses the fluid under the action of an electric stratification actuator 45.

The hydraulic stratification output piston 44 may have joints for forming a seal with a cylinder with which it interacts.

The electric stratification actuator 45 of the high-pressure spark and stratification ignition device 2 consists of at least one coil of conductive wire 46 which attracts a magnetic core or blade 47 when electric current flows through the coil 46, in such a way that the core or blade 47 pushes the hydraulic stratification output piston 44 via core or blade transmission means 48 so that the piston 44 compresses the hydraulic fluid contained in the hydraulic output chamber 42 (FIGS. 2 and 3).

In a variant embodiment (not shown), the electric stratification actuator 45 may consist of at least one stack of piezoelectric layers whose thickness varies when they are subjected to a flow of electric current, in such a way that the stack pushes the hydraulic stratification output piston 44 via piezoelectric layer stack transmission means so that the piston 44 compresses the hydraulic fluid contained in the hydraulic output chamber 42.

The core or blade transmission means 48 of the electric stratification actuator 45 consist of a push rod for the hydraulic stratification output piston 49 (FIGS. 2 to 5).

In an embodiment which is not shown, the hydraulic stratification receiving chamber 37 of the stratification actuator 27 may be connected to a high-pressure hydraulic control fluid reservoir and/or to a low-pressure hydraulic control fluid reservoir by at least one high-pressure solenoid valve and/or by at least one low-pressure solenoid valve.

The high-pressure hydraulic control fluid reservoir is pressurized by a hydraulic control pump, this pump transferring a hydraulic fluid tapped from the low-pressure hydraulic control fluid reservoir to the high-pressure hydraulic control fluid reservoir.

The hydraulic stratification receiving chamber 37 of the stratification actuator 27 is connected directly or indirectly to a pressurized lubrication circuit 14 incorporated in the internal combustion engine 1 by a check valve 15, this valve allowing a hydraulic fluid contained in the circuit to flow from the circuit toward the chamber, but not in the reverse direction (FIGS. 2 to 5).

It should be noted that the check valve 15 serves to resupply hydraulic fluid to the hydraulic stratification receiving chamber 37 if a leak occurs in this chamber, or to compensate for losses of hydraulic fluid from the chamber following the intentional leak created by the pressure drop conduit 16 which is incorporated in a particular embodiment of the device according to the invention.

The hydraulic stratification receiving chamber 37 of the stratification actuator 27 is connected directly or indirectly to the pressurized lubrication circuit 14 incorporated in the internal combustion engine by a pressure drop conduit 16, this conduit having a small cross section and/or a long length relative to its cross section, and/or having an internal shape which does not favor the establishment of a laminar flow, between the circuit and the chamber, of a hydraulic fluid contained in the circuit and/or the chamber.

It should be noted that the pressure drop conduit 16 serves to allow the hydraulic fluid to flow in relatively large quantities from the chamber 37 to the circuit 14 or vice versa over a long time interval during the phases of temperature increase or reduction of the internal combustion engine 1, while the hydraulic fluid can only escape in very small quantities from the chamber 37 toward the circuit 14 in the short time intervals characterized by the period between two opening and closing cycles of the low-lift stratification valve 20 according to the invention.

FIG. 6 shows an embodiment of the stratification actuator 27 which consists of a coil of conductive wire 50 integral with the cylinder head 8 of the internal combustion engine 1, the coil attracting a magnetic blade 51 when electric current flows through the coil, in such a way that the blade 51 displaces in a longitudinal translational manner the low-lift stratification valve 20 to which it is connected.

FIG. 7 shows another embodiment of the stratification actuator 27 which consists of a stack of piezoelectric layers 52 whose thickness varies when they are subjected to a flow of electric current, in such a way that the stack displaces in a longitudinal translational manner the low-lift stratification valve 20 to which it is connected.

The stack of piezoelectric layers 52 is connected to the low-lift stratification valve 20 by means of at least one lever 53 which multiplies the displacement imparted by the stack to the valve.

The lever 53 may consist, for example, of a washer formed by a succession of small levers interconnected in a circular manner, each small lever bearing on the top of the stack of piezoelectric layers 52 on the one hand, and on the low-lift stratification valve 20 on the other hand.

In an embodiment which is not shown, the stratification actuator 27 consists of a pneumatic stratification pump comprising a pneumatic stratification receiving chamber and a pneumatic stratification receiving piston, the piston being integral with the low-lift stratification valve 20 or being connected thereto by pneumatic piston thrust means, while the pneumatic chamber can be connected to a high-pressure air chamber or to the open air or to a low-pressure air chamber by at least one solenoid valve.

It should be noted that the end of the stratification conduit 23 opening into the combustion chamber 9 of the internal combustion engine 1 includes a stratification deflector 54 (FIGS. 4 and 5).

The deflector 54 serves to channel the flow of fuel-air mixture expelled from the stratification chamber 24 toward the combustion chamber 9, so as to impart turbulent motions around the electrodes 26 of the spark plug 25 to the mixture, these motions being such that they facilitate the initiation and development of the combustion of the mixture when an electric arc is struck at the terminals of the spark plug 25 by the flow of a high-voltage electric current between the electrodes 26.

It should also be noted that the stratification fuel injector 33 is connected to a reservoir of pressurized combustible gas 55 (FIG. 9).

The gas may be injected by the injector 33 and may be, for example, compressed natural gas or any other combustible gas used by reciprocating internal combustion heat engines.

FIGS. 8 and 10 show the atmospheric air supply circuit 31 of the stratification chamber 24, including a homogenization circulator 56.

The homogenization circulator 56 is placed at any point of the supply circuit 31 and agitates atmospheric air or a gas mixture contained in the circuit while causing the air or mixture to circulate through the circuit.

The atmospheric air supply circuit 31 of the stratification chamber 24 includes an air-to-air heat exchanger 57 for heating the supply circuit 31, which heats atmospheric air or a gas mixture contained in the circuit by extracting heat from the exhaust gases of the internal combustion engine 1, the air or gas mixture and the exhaust gases flowing simultaneously through the exchanger 57 without mixing with one another (FIG. 10).

The atmospheric air supply circuit 31 of the stratification chamber 24 includes at least one electrical resistance for heating the supply circuit (not shown), which heats atmospheric air or a gas mixture contained in the circuit.

In a particular embodiment, the internal surface of the atmospheric air supply circuit 31 of the stratification chamber 24 may be wholly or partially covered with a thermal insulation material which may be ceramic, air, or any other thermal insulation means known to those skilled in the art.

FIG. 9 shows the atmospheric air supply circuit 31 of the stratification chamber 24, including an air-to-water heat exchanger of the supply circuit 58, which cools atmospheric air or a gas mixture contained in the circuit by surrendering heat contained in the atmospheric air or gas mixture to a heat transfer fluid contained in a cooling circuit 17 incorporated in the internal combustion engine 1.

It should be noted that, in one embodiment, the stratification chamber 24 may include at least one tangential inlet and/or at least one tangential outlet, so that the inlet and/or outlet serve to impart a turbulent motion to the atmospheric air or to the gas mixture arriving from the stratification line 28 when the air or mixture is introduced into the chamber.

It should be noted that the atmospheric air supply circuit 31 of the stratification chamber 24 may include at least one agitation chamber which imparts a turbulent motion to a gas mixture which is moving in the circuit, or which causes the gas mixture to undergo rapid pressure variations.

The agitation chamber may, for example, provide a Venturi effect so as to promote the evaporation of the fuel in the mixture on the one hand, and the agitation of the mixture on the other hand.

FIG. 10 shows the stratification line 28 which includes at least one discharge valve 59 which opens above a certain pressure level established in the line.

The outlet of the discharge valve 59 may open, in a particular embodiment of the device according to the invention, into the intake plenum 19 or into the exhaust circuit 10 of the internal combustion engine 1, or to the outside air.

The stratification line 28 and/or the outlet of the stratification compressor 29 and/or the stratification chamber 24 include at least one discharge solenoid valve (not shown) whose outlet opens at the intake of the internal combustion engine 1, or into a canister, or into a storage reservoir (which is not shown).

It should be noted that the solenoid valve may be actuated so as to open when the internal combustion engine 1 stops, in such a way that the canister or the reservoir stores most of the hydrocarbon vapor contained in the stratification line 28 and/or in the outlet of the stratification compressor 29 and/or in the stratification chamber 24, the vapors being burnt when the engine is subsequently restarted, or in such a way that the vapors are burnt immediately by the engine when they are expelled at the intake of the engine by the solenoid valve.

It should be noted in FIG. 9 that the outlet of the stratification compressor 29 is connected to a pressure accumulator 60 which stores atmospheric air or a gas mixture previously pressurized by the compressor, the accumulator 60 also communicating directly or indirectly with the stratification line 28 and the stratification chamber 24 so as to keep the line and chamber under pressure.

The pressure accumulator 60 serves, notably, to stabilize the pressure established in these members in the case in which, for example, the stratification compressor 29 includes a single piston rotating at low speed, this configuration generating high-amplitude pressure waves within these members.

It should be noted that, in a particular embodiment, the low-lift stratification valve 20 and the spark plug 25 may be contained in a single stratification cartridge 61 screwed into the cylinder head 8 of the internal combustion engine 1 (FIGS. 2 and 3).

In a particular embodiment of the device according to the invention, the stratification cartridge 61 may contain all or part of the stratification actuator 27 and any fluid inlets and outlets thereof, may have inlets and outlets for the atmospheric air or the fuel-air mixture carried by the atmospheric air supply circuit 31 of the stratification chamber 24, and may include one or more joints or segments 62 providing a seal between the cartridge 61 and the cylinder head 8, the segment nearest to the combustion chamber 9 of the internal combustion engine 1 also providing cooling for the cartridge.

It should be noted that the spark plug 25 and the low-lift stratification valve 20 may be made in the same block of material.

In one embodiment, the spark plug 25 is mounted by being screwed into the low-lift stratification valve 20.

In this configuration, the valve may include means which lock it rotationally relative to the cylinder head 8 of the internal combustion engine 1 in order to facilitate the fitting and removal, and the tightening and release, of the spark plug 25 in the low-lift stratification valve 20, in which case the spark plug is mounted in the engine in the same way as any other spark plug known to those skilled in the art.

FIGS. 8 to 10 show the previously cooled exhaust gas recirculation means 40, called “external cooled EGR” means, of the high-pressure spark and stratification ignition device 2 according to the present invention.

The means for recirculating previously cooled exhaust gases 40, called “external cooled EGR” means, consist of at least one proportional-lift EGR tapping valve 63 or at least one proportional-rotation EGR tapping flap valve 64 or at least one proportional-rotation EGR tapping sleeve valve 65 positioned on the exhaust manifold 18 of the internal combustion engine 1, the valve, flap valve or sleeve valve being capable of connecting the manifold to an external EGR supply conduit 66 having an end, opposite the end opening into the manifold, which opens into the intake plenum 19 of the engine.

The proportional-lift EGR tapping valve 63, or the proportional-rotation EGR tapping flap valve 64, or the proportional-rotation EGR tapping sleeve valve 65 positioned on the exhaust manifold 18 interacts with at least one proportional-lift counter-pressure exhaust valve 67 or with a proportional-rotation counter-pressure exhaust flap valve 68 or with a proportional-rotation counter-pressure sleeve valve 69 incorporated in at least one of the outlets of the manifold.

The stratification EGR cooler 41 may be a high-temperature air-to-water heat exchanger in the external EGR supply conduit which cools the exhaust gases tapped from the exhaust conduit 10 of the internal combustion engine 1, these gases surrendering some of their heat to a heat transfer fluid contained in the cooling circuit 17 of the engine.

The stratification EGR cooler 41 may be a low-temperature air-to-water heat exchanger in the external EGR supply conduit which cools the exhaust gases tapped from the exhaust conduit 10 of the internal combustion engine 1, these gases surrendering some of their heat to a heat transfer fluid contained in an independent cold water circuit incorporated in the internal combustion engine.

It should be noted that the cold water circuit may be that of the supercharger air cooler incorporated in the engine, a circuit of this type being known to those skilled in the art.

FIG. 9 shows the stratification line 28 and/or the stratification compressor outlet 29 and/or the stratification chamber 24 which includes at least one valve or injector for a fuel-air mixture 76 for keeping a catalytic converter 75 at a given temperature, the valve or injector 76 being capable of transferring a fuel-air mixture from the line 28, from the outlet or from the chamber 24 toward the exhaust conduit 10 of the internal combustion engine 1, the mixture being introduced by the valve or injector 76 into the conduit 10 at any point of the conduit located between the exhaust valve 12 of the engine and the catalytic converter for post-treating the pollutants 75 from the engine 1.

Thus, if necessary, the mixture may be introduced into the exhaust valve 10 after the catalytic converter 75 for post-treating pollution has reached an operating temperature at which it can operate with at least adequate efficiency, in order to ensure that the mixture is burnt in the catalytic converter 75 in such a way that the latter is kept at a sufficient temperature to enable it to maintain a high pollutant to non-pollutant gas conversion efficiency.

The fuel-air mixture valve or injector (76) for keeping a catalytic converter (75) at a given temperature is connected to the exhaust conduit (10) of the internal combustion engine (1) by a conduit (77) for a fuel-air mixture for keeping a catalytic converter at a given temperature, while it is also possible for the mixture conduit 77 to include an insulating tube or flange 78 which prevents the conduit 77 from reaching an excessively high temperature.

### Operation of the Invention

The ignition device according to the invention operates in at least the following modes:
Combustion of a stoichiometric pilot charge only, the main charge not containing, in practice, either oxygen or fuel, but solely external cooled EGR and/or internal hot EGR.
Combustion of a stoichiometric pilot charge which then ignites a stoichiometric main charge which is highly diluted with external cooled EGR and/or internal hot EGR.
Combustion of a stoichiometric pilot charge which then ignites a stoichiometric main charge which is undiluted or only slightly diluted with external cooled EGR and/or internal hot EGR.
Combustion of a stoichiometric pilot charge only which is highly diluted, undiluted or only slightly diluted with external cooled EGR and/or internal hot EGR.

In a particular embodiment and use, the ignition device according to the invention operates as follows, for example when used in a four-cylinder reciprocating internal combustion heat engine as shown in FIGS. 8 to 10:

Phase of pressurization of the stratification line 28: the engine 1 is started in the same way as a prior art engine with multipoint injection, the ignition device 2 according to the invention not being used at this stage, except as regards the spark plug 25 included in the device.

Being directly driven by the crankshaft 7 of the engine according to this example, the stratification compressor 29 is put into operation at the same time as the crankshaft and draws in its own air tapped from the outlet of the air filter housing 70 of the engine.

In this particular embodiment, an injector 33 sprays fuel into the intake of the stratification compressor 29 in such proportions that a stoichiometric fuel-air mixture is delivered at the outlet of the compressor, directly into the stratification line 28.

In parallel with the action of the stratification compressor 29, the homogenization circulator 56 causes the stoichiometric fuel-air mixture to flow subsequently through the stratification line 28, through the various stratification chambers 24 incorporated in each combustion cylinder 4 of the internal combustion engine 1 as specified by the invention, and then through the homogenization return conduit 71 so as to return to the circulator and start out again on the same circuit as long as the line 28 is pressurized and the internal combustion engine remains in operation.

The agitation created by the homogenization circulator 56 serves to reduce the condensation of the gasoline contained in the stoichiometric fuel-air mixture on the internal walls of the stratification line 28 and of the stratification chambers 24, the mixture being under pressure and therefore unfavorable to the maintenance of the vapor state of the gasoline.

This agitation also serves to force the stoichiometric fuel-air mixture to remain homogeneous and at a temperature close to that of the walls, this temperature being below the spontaneous ignition point of the mixture, and to clean the walls, notably by rediluting any gasoline residues adhering to the walls as a result of previous use of the ignition device according to the invention.

Under the action of the stratification compressor 29, the pressure of the stratification line 28 rises to a level greater than the pressure established in the combustion chamber 9 of the internal combustion engine 1 when the piston 5 of the latter reaches the end of its compression stroke, immediately before the ignition of the charge contained in the chamber. When the line has been pressurized, the ignition device according to the invention is ready to stratify the charge of the engine, which takes place as follows:

### Phase of Initial Stratification:

A few degrees of rotation of the crankshaft 7 of the engine before the initiation of the spark ignition of the main stoichiometric charge contained in the combustion chamber 9 of the engine by means of the spark plug 25, an electric current is sent to the terminals of the coil 46 of the electric stratification actuator 45 (FIG. 3).

The magnetic core 47 of the actuator is then attracted by the coil and starts to move toward the latter, pushing on the hydraulic stratification output piston 44, which then pressurizes the chamber of the hydraulic stratification pump 36, thus compressing the hydraulic fluid contained in the pump.

The low-lift stratification valve 20 is then lifted by an amount from a few hundredths of a millimeter to about a tenth of a millimeter from its seat 21, by the thrust of the piston of the hydraulic stratification pump 36, and a fraction of the pressurized fuel-air mixture contained in the stratification line 28, and more precisely in the stratification chamber 24, escapes toward the combustion chamber 9 of the engine 1.

While escaping, the mixture is agitated by a turbulent motion while remaining confined in a small volume centered around the electrodes 26 of the spark plug 25, the plug being fixed and centered on the low-lift stratification valve 20, and the mixture forming the stoichiometric pilot charge (FIG. 3).

When the desired quantity of mixture has been transferred from the stratification chamber 24 toward the combustion chamber 9 to form the pilot charge, the coil 46 of the electric stratification actuator 45 ceases to be supplied with electric current, and the magnetic core 47 of the actuator is pushed back to its initial position by the hydraulic stratification output piston 44, the latter being itself pushed back by the hydraulic fluid contained in the hydraulic stratification pump 36.

The low-lift stratification valve 20 then returns to the closed position under the action of the Belleville spring washers which form its return spring 22 and which keep the hydraulic stratification pump 36 under pressure when the valve is open.

The pilot charge is then ignited, a high-voltage current being applied to the terminals of the spark plug 25 so as to form an electric arc between the electrodes 26 of the spark plug. Since the pilot charge is stoichiometric and has a strong turbulent motion, it is ignited rapidly, and then forms a substantially spherical hot volume which expands rapidly under the effect of heat to form a substantially truncated spherical flame front with a large surface area in contact with the main charge, which is also rapidly ignited, because the distance which the flame still has to cover in order to burn the whole of the main charge is short. When this mode of combustion by pilot charge and main charge has been established, the previously cooled exhaust gas recirculation means 40, called “external cooled EGR” means, come into operation as follows:

Phase of Dilution of the Charge with External Cooled EGR:

In order to recirculate the exhaust gases, the previously cooled exhaust gas recirculation means 40 according to the invention and according to the present exemplary embodiment may include a proportional-lift EGR tapping valve 63 positioned on an exhaust manifold 18 which links the exhaust outlets of the cylinders A and B of the internal combustion engine 1 to one another and which is incorporated in the engine, the tapping valve 63 interacting with a proportional-lift counter-pressure exhaust valve 67 positioned at the outlet of the manifold 18.

When the EGR tapping valve 63 is fully open and the counter-pressure exhaust valve 67 is fully closed, all the exhaust gases from cylinders A and B are reintroduced into the intake plenum 19 of the internal combustion engine 1 via the tapping valve 63 and the external EGR supply conduit 66, the latter including an external EGR air-to-water cooler of the hot air type 72, in other words a cooler in which the water is that used to cool the engine itself, into which the gases flow to undergo a first temperature reduction, after which they flow into an air-to-water cooler of the cold air type 73 contained in the intake plenum 19 to undergo a second temperature reduction, the latter cooler also serving to cool the supercharging air of the engine when the engine is supercharged by its turbocompressor 74 (FIG. 8).

With this configuration and this setting, the air admitted at the intake of the engine 1 contains approximately fifty percent EGR and is at a temperature only a few degrees higher than that of the ambient air.

It can easily be deduced from this arrangement that the engine can be made to operate at between zero and fifty percent of external cooled EGR by varying the respective lift of the EGR tapping valves 63 and the counter-pressure exhaust valves 67 incorporated in the exhaust manifold 18 of the exhaust outlets of cylinders A and B, the appropriate level of EGR being set at all times by the engine operating computer ECU according to a criterion of better energy efficiency and stability limits on the combustion of the engine.

It should be noted that, when the turbocompressor 74 of the engine 1 is used to supercharge the latter, the EGR tapping valve 63 and the counter-pressure exhaust valve 67 are set in such a way that enough energy remains in the exhaust gases to allow the turbocompressor turbine to drive the centrifugal compressor incorporated in the turbocompressor in the desired conditions.

This requirement to reduce the EGR level in order to prioritize the energy available for the turbine has a smaller negative effect on the final efficiency of the engine when the engine has a variable compression rate and requires little or no external cooled EGR at full load in order to overcome pinging and/or to deliver high energy efficiency.

It should be noted that, when the engine 1 operates with high levels of external cooled EGR, combustion which is normally difficult or even impossible to initiate in the absence of the ignition device 2 according to the invention is made possible by this device in good conditions.

This is because the initiation of combustion of the stoichiometric main charge which is highly diluted with external cooled EGR is provided by the flame front with a large surface area developed on the periphery of the pilot charge and brought into contact with the main charge.

In this context, the main charge burns rapidly as a result, firstly, of the compression created by the combustion of the pilot charge, this compression increasing the enthalpy of the main charge which is as yet unburnt; secondly, of the large contact surface exposed to the flame; and thirdly, of the small distance still to be covered by the flame in order to burn all the main charge.

Since it is highly diluted with external cooled EGR, the mean temperature of the charge during combustion is lowered considerably, simultaneously reducing the sensitivity of the engine to pinging and the heat losses at the walls. It is then possible to initiate the combustion of the charge at the optimal moment according to a criterion of maximum efficiency, and to increase the compression rate of the engine, which may be fixed or variable, in order to increase the thermodynamic efficiency of the gas expansion.

It should be noted that, in the case of an engine with a variable compression rate, the mean external cooled EGR content of the charge may advantageously be increased in parallel with the compression rate, the increase of this rate being simultaneously favorable to the stability of combustion with a high level of external cooled EGR and to the thermodynamic efficiency of the gas expansion.

In the non-limiting embodiment of the ignition device 2 according to the invention as described above, the piston of the hydraulic stratification pump 38 interacts with a check valve 15 and a pressure drop conduit 16.

These two members serve to enable the hydraulic fluid contained in the hydraulic receiving chamber 37 of the hydraulic stratification pump 36 to expand over a long time interval during the rise in temperature of the engine 1, while allowing the excess volume of hydraulic fluid to escape through the pressure drop conduit 16, and to contract, again over a long time interval, during the reduction in temperature of the engine, via the check valve 15 and the pressure drop conduit 16.

The check valve 15 also serves to resupply hydraulic fluid to the hydraulic receiving chamber 37 of the hydraulic stratification pump 36 in each opening and closing cycle of the low-lift stratification valve 20, in order to compensate for any leaks that may occur at the position of the hydraulic receiving piston 38 of the hydraulic stratification pump 36 on the one hand, and to compensate for the deliberate leak which the pressure drop conduit 16 inevitably creates on the other hand.

It should be noted that the length, cross section and shape of the pressure drop conduit 16 are designed to allow the compensation of the expansion and retraction of the oil due to temperature variations over a long time interval, and to cause the least possible disturbance to the operation of the low-lift stratification valve 20 over a short time interval, cycle by cycle.

It should be noted that, on completion of the phase of pressurizing the stratification line 28, the phases of stratification and subsequent dilution of the charge with external cooled EGR may be delayed in time so as to allow the fuel stored in the line at the time of the last use of the internal combustion engine 1 to return to the vapor state as a result of the rise in temperature of the internal walls of the line and the agitation provided by the homogenization circulator 56.

This delay also enables all the energy contained in the exhaust gases of the engine to be reserved temporarily for the heating of the three-way catalytic converter of the engine before the charge of the engine is diluted with external cooled EGR.

It should be noted that the ignition device 2 according to the invention may enable combustion to be initiated in a single engine in two different modes, the first mode being controlled spark ignition and used for the pilot charge, while the second mode is ignition initiated by compression according to the principles of CAI and HCCI and is used for the main charge.

According to this method of using the ignition device 2 according to the invention, the external cooled EGR may be entirely or partially replaced by internal hot EGR, so that the conditions of temperature, pressure and composition required for the correct initiation of combustion by CAI or HCCI can be provided for the main charge.

It should be noted that this initiation of combustion in two different modes in the same engine cycle is easier to control if it is used in a variable compression rate engine.

In a particular mode of use of the ignition device 2 according to the invention, the internal combustion engine may advantageously have a device for controlling the opening and/or closing and/or lifting of its intake valves 13 and/or its exhaust valves 12, in addition to or instead of a variable compression rate.

This particular embodiment may be used, notably, to advance the closing of the intake valve 13 during the intake stroke of the combustion piston 5 of the engine 1, in order to reduce its residual pumping losses at low loads.

The last-mentioned method may be used, for example, to provide a very high compression ratio for the engine 1, in which the very high expansion rate of the gases is favorable to high thermodynamic efficiency.

It is to be understood that the above description is provided purely by way of example, and does not in any way limit the scope of the invention, from which there would be no departure if the details of embodiment which have been described were to be replaced by any other equivalents.

1. High-pressure spark and stratification ignition device for an internal combustion engine (1), the engine comprising a cylinder head (8) having at least one combustion chamber (9) into which there open an intake conduit (11) communicating with an intake plenum (19) and an exhaust conduit (10) with an exhaust manifold (18) and a catalytic converter (75) for treatment of the pollutants, the engine further comprising a pressurized lubrication circuit (14), a cooling circuit (17), and an ECU computer, characterized in that it comprises:
at least one low-lift stratification valve (20) kept in contact with a seat (21) by at least one spring (22), this valve closing the end of a stratification conduit (23) and this end of the stratification conduit opening into the combustion chamber (9) of the internal combustion engine (1), while the stratification conduit (23) connects at least one stratification chamber (24) to the combustion chamber (9);
at least one spark plug (25) housed in the low-lift stratification valve (20), this spark plug having projecting electrodes (26) positioned in the combustion chamber (9) of the engine (1);
at least one stratification actuator (27) controlled by the ECU computer of the internal combustion engine (1), this actuator being responsible for lifting the low-lift stratification valve (20) from its seat (21), keeping it open, and returning it to its seat;
at least one stratification line (28) connecting the stratification chamber (24) to the outlet of a stratification compressor (29) whose inlet is connected directly or indirectly to a stratification atmospheric air supply conduit (30), the line, the compressor, its inlet and outlet, and the supply conduit forming in combination an atmospheric air supply circuit (31) of the stratification chamber (24), while the chamber itself forms an integral part of the circuit;
at least one stratification fuel injector (33) controlled by the ECU computer of the internal combustion engine (1), the injector being capable of producing a jet of fuel within the atmospheric air supply circuit (31) of the stratification chamber (24), at any point of the circuit;
at least means for recirculating previously cooled exhaust gases (40), called “external cooled EGR” means, controlled by the ECU computer of the internal combustion engine (1), these means making it possible to tap exhaust gases from the exhaust conduit (10) of the engine and then to reintroduce the gases at the intake of the engine after the gases have been cooled by means of at least one cooler (41).

2. High-pressure spark and stratification ignition device for an internal combustion engine according to claim 1, characterized in that the spark plug (25) is fixed to the low-lift stratification valve (20) so as to be integral with the valve in its longitudinal translational movement.

3. High-pressure spark and stratification ignition device for an internal combustion engine according to claim 1, characterized in that the spark plug (25) is fixed to the cylinder head (8) of the internal combustion engine (1), the low-lift stratification valve (20) moving only with respect to the cylinder head and with respect to the spark plug.

4. High-pressure spark and stratification ignition device for an internal combustion engine according to claim 1, characterized in that the seat (21) of the low-lift stratification valve (20) has a face which is oriented toward the outside of the combustion chamber (9) of the internal combustion engine (1) in such a way that the stratification actuator (27) can only lift the valve from the seat by moving the valve away from the chamber.

5. High-pressure spark and stratification ignition device for an internal combustion engine according to claim 1, characterized in that the seat (21) of the low-lift stratification valve (20) has a face which is oriented toward the inside of the combustion chamber (9) of the internal combustion engine (1) in such a way that the stratification actuator (27) can only lift the valve from the seat by moving the valve toward the chamber.

6. High-pressure spark and stratification ignition device for an internal combustion engine according to claim 1, characterized in that the stratification actuator (27) consists of a hydraulic stratification pump (36) comprising a hydraulic stratification receiving chamber (37) and a hydraulic stratification receiving piston (38), the piston being integral with the low-lift stratification valve (20) or being connected thereto by hydraulic piston thrust means.

7. High-pressure spark and stratification ignition device for an internal combustion engine according to claim 6, characterized in that the hydraulic stratification receiving chamber (37) is connected to a hydraulic stratification output chamber (42) by at least one conduit (43), the hydraulic fluid contained in the hydraulic output chamber (42) being pressurizable by a hydraulic stratification output piston (44) when the latter compresses the fluid under the action of an electric stratification actuator (45).

8. High-pressure spark and stratification ignition device for an internal combustion engine according to claim 7, characterized in that the electric stratification actuator (45) consists of at least one coil of conductive wire (46) which attracts a magnetic core or blade (47) when electric current flows through the coil, in such a way that the core or blade pushes the hydraulic stratification output piston (44) via core or blade transmission means (48) so that the piston (44) compresses the hydraulic fluid contained in the hydraulic output chamber (42).

9. High-pressure spark and stratification ignition device for an internal combustion engine according to claim 7, characterized in that the electric stratification actuator (45) consists of at least one stack of piezoelectric layers whose thickness varies when they are subjected to a flow of electric current, in such a way that the stack pushes the hydraulic stratification output piston (44) via stack transmission means so that the piston compresses the hydraulic fluid contained in the hydraulic output chamber (42).

10. High-pressure spark and stratification ignition device for an internal combustion engine according to claim 8, characterized in that the core or blade transmission means (48) consist of a push rod for the hydraulic stratification output piston (49).

11. High-pressure spark and stratification ignition device for an internal combustion engine according to claim 6, characterized in that the hydraulic stratification receiving chamber (37) may be connected to a high-pressure hydraulic control fluid reservoir and/or to a low-pressure hydraulic control fluid reservoir by at least one high-pressure solenoid valve and/or by at least one low-pressure solenoid valve.

12. High-pressure spark and stratification ignition device for an internal combustion engine according to claim 11, characterized in that the high-pressure hydraulic control fluid reservoir is pressurized by a hydraulic control pump, this pump transferring a hydraulic fluid tapped from the low-pressure hydraulic control fluid reservoir to the high-pressure hydraulic control fluid reservoir.

13. High-pressure spark and stratification ignition device for an internal combustion engine according to claim 6, characterized in that the hydraulic stratification receiving chamber (37) is connected directly or indirectly to the pressurized lubrication circuit (14) of the internal combustion engine (1) by a check valve (15), this valve allowing a hydraulic fluid contained in the circuit to flow from the circuit toward the chamber, but not in the reverse direction.

14. High-pressure spark and stratification ignition device for an internal combustion engine according to claim 6, characterized in that the hydraulic stratification receiving chamber (37) is connected directly or indirectly to the pressurized lubrication circuit (14) of the internal combustion engine (1) by a pressure drop conduit (16), this conduit having a small cross section and/or a long length relative to its cross section, and/or having an internal shape which does not favor the establishment of a laminar flow, between the circuit and the chamber, of a hydraulic fluid contained in the circuit and/or the chamber.

15. High-pressure spark and stratification ignition device for an internal combustion engine according to claim 1, characterized in that the stratification actuator (27) consists of at least one coil of conductive wire (50) which is integral with the cylinder head (8) of the internal combustion engine (1), the coil attracting a magnetic blade (51) when electric current flows through the coil, in such a way that the blade pushes the low-lift stratification valve (20) to which it is connected so as to cause its longitudinal translation.

16. High-pressure spark and stratification ignition device for an internal combustion engine according to claim 1, characterized in that the stratification actuator (27) consists of at least one stack of piezoelectric layers (52) whose thickness varies when they are subjected to a flow of electric current, in such a way that the stack pushes the low-lift stratification valve (20) to which it is connected so as to cause its longitudinal translation.

17. High-pressure spark and stratification ignition device for an internal combustion engine according to claim 16, characterized in that the stack of piezoelectric layers (52) is connected to the low-lift stratification valve (20) by means of at least one lever (53) which multiplies the displacement imparted by the stack to the valve.

18. High-pressure spark and stratification ignition device for an internal combustion engine according to claim 1, characterized in that the stratification actuator (27) consists of a pneumatic stratification pump comprising a pneumatic stratification receiving chamber and a pneumatic stratification receiving piston, the piston being integral with the low-lift stratification valve (20) or being connected thereto by pneumatic piston thrust means, while the pneumatic chamber can be connected to a high-pressure air chamber and/or to the open air and/or to a low-pressure air chamber by at least one solenoid valve.

19. High-pressure spark and stratification ignition device for an internal combustion engine according to claim 1, characterized in that the end of the stratification conduit (23) opening into the combustion chamber (9) of the internal combustion engine (1) includes a stratification deflector (54).

20. High-pressure spark and stratification ignition device for an internal combustion engine according to claim 1, characterized in that the stratification fuel injector (33) is connected to a reservoir of pressurized combustible gas (55).

21. High-pressure spark and stratification ignition device for an internal combustion engine according to claim 1, characterized in that the atmospheric air supply circuit (31) of the stratification chamber (24) includes a homogenization circulator (56), the circulator being placed at any point of the circuit and agitating atmospheric air or a gas mixture contained in the circuit while causing the air or mixture to circulate through the circuit.

22. High-pressure spark and stratification ignition device for an internal combustion engine according to claim 1, characterized in that the atmospheric air supply circuit (31) of the stratification chamber (24) includes an air-to-air heat exchanger (57) for heating the supply circuit (31), which heats atmospheric air or a gas mixture contained in the circuit by extracting heat from the exhaust gases of the internal combustion engine (1), the air or gas mixture and the exhaust gases flowing simultaneously through the exchanger (57) without mixing with one another.

23. High-pressure spark and stratification ignition device for an internal combustion engine according to claim 1, characterized in that the atmospheric air supply circuit (31) of the stratification chamber (24) includes at least one electrical resistance for heating the supply circuit, which heats atmospheric air or a gas mixture contained in the circuit.

24. High-pressure spark and stratification ignition device for an internal combustion engine according to claim 1, characterized in that the internal surface of the atmospheric air supply circuit (31) of the stratification chamber (24) is wholly or partially covered with a thermal insulation material.

25. High-pressure spark and stratification ignition device for an internal combustion engine according to claim 1, characterized in that the atmospheric air supply circuit (31) of the stratification chamber (24) includes an air-to-water heat exchanger for cooling the supply circuit (58), which cools atmospheric air or a gas mixture contained in the circuit by surrendering heat from the atmospheric air or gas mixture to a heat transfer fluid contained in the cooling circuit (17) of the internal combustion engine (1).

26. High-pressure spark and stratification ignition device for an internal combustion engine according to claim 1, characterized in that the stratification chamber (24) has at least one tangential inlet and/or at least one tangential outlet.

27. High-pressure spark and stratification ignition device for an internal combustion engine according to claim 1, characterized in that the atmospheric air supply circuit (31) of the stratification chamber (24) includes at least one agitation chamber which imparts a turbulent motion to a gas mixture which is moving in the circuit, or which causes the gas mixture to undergo rapid pressure variations.

28. High-pressure spark and stratification ignition device for an internal combustion engine according to claim 1, characterized in that the stratification line (28) includes at least one discharge valve (59) which opens above a certain pressure level established in the line.

29. High-pressure spark and stratification ignition device for an internal combustion engine according to claim 1, characterized in that the stratification line (28) and/or the outlet of the stratification compressor (29) and/or the stratification chamber (24) include at least one discharge solenoid valve whose outlet opens at the intake of the internal combustion engine, or into a canister, or into a storage reservoir.

30. High-pressure spark and stratification ignition device for an internal combustion engine according to claim 1, characterized in that the outlet of the stratification compressor (29) is connected to a pressure accumulator (60) which stores atmospheric air or a gas mixture previously pressurized by the compressor, the accumulator also communicating directly or indirectly with the stratification line (28) and the stratification chamber (24) so as to keep the line and chamber under pressure.

31. High-pressure spark and stratification ignition device for an internal combustion engine according to claim 1, characterized in that the low-lift stratification valve (20) and the spark plug (25) are contained in a single stratification cartridge (61) screwed into the cylinder head (8) of the internal combustion engine (1).

32. High-pressure spark and stratification ignition device for an internal combustion engine according to claim 1, characterized in that the spark plug (25) and the low-lift stratification valve (20) are made in the same block of material.

33. High-pressure spark and stratification ignition device for an internal combustion engine according to claim 1, characterized in that the spark plug (25) is mounted in the low-lift stratification valve (20).

34. High-pressure spark and stratification ignition device for an internal combustion engine according to claim 1, characterized in that the means for recirculating previously cooled exhaust gases (40), called “external cooled EGR” means, consist of at least one proportional-lift EGR tapping valve (63) or at least one proportional-rotation EGR tapping flap valve (64) or at least one proportional-rotation EGR tapping sleeve valve (65) positioned on the exhaust manifold (18) of the internal combustion engine (1), the valve, flap valve or sleeve valve being capable of connecting the manifold to an external EGR supply conduit (66) having an end, opposite the end opening into the manifold, which opens into the intake plenum (19) of the engine.

35. High-pressure spark and stratification ignition device for an internal combustion engine according to claim 34, characterized in that the proportional-lift EGR tapping valve (63), or the proportional-rotation EGR tapping flap valve (64), or the proportional-rotation EGR tapping sleeve valve (65) positioned on the exhaust manifold (18) interacts with at least one proportional-lift counter-pressure exhaust valve (67) or with a proportional-rotation counter-pressure exhaust flap valve (68) or with a proportional-rotation counter-pressure sleeve valve (69) incorporated in at least one of the outlets of the manifold.

36. High-pressure spark and stratification ignition device for an internal combustion engine according to claim 1, characterized in that the stratification EGR cooler (41) is a high-temperature air-to-water heat exchanger in the external EGR supply conduit which cools the exhaust gases tapped from the exhaust conduit (10) of the internal combustion engine (1), these exhaust gases surrendering some of their heat to a heat transfer fluid contained in the cooling circuit (17) of the internal combustion engine.

37. High-pressure spark and stratification ignition device for an internal combustion engine according to claim 1, characterized in that the stratification EGR cooler (41) is a low-temperature air-to-water heat exchanger in the external EGR supply conduit which cools the exhaust gases tapped from the exhaust conduit (10) of the internal combustion engine (1), these exhaust gases surrendering some of their heat to a heat transfer fluid contained in an independent cold water circuit incorporated in the internal combustion engine.

38. High-pressure spark and stratification ignition device for an internal combustion according to claim 1, characterized in that the stratification line (28) and/or the stratification compressor outlet (29) and/or the stratification chamber (24) includes at least one valve or injector for a fuel-air mixture (76) for keeping a catalytic converter (75) at a given temperature, the valve or injector (76) being capable of transferring a fuel-air mixture from the line (28), from the outlet or from the chamber (24) toward the exhaust conduit (10) of the internal combustion engine (1), the mixture being introduced by the valve or injector (76) into the conduit (10) at any point of the conduit located between the exhaust valve (12) of the engine and the catalytic converter for post-treating the pollutants (75) from the engine (1).

39. High-pressure spark and stratification ignition device for an internal combustion engine according to claim 38, characterized in that the fuel-air mixture valve or injector (76) for keeping a catalytic converter (75) at a given temperature is connected to the exhaust conduit (10) of the internal combustion engine (1) by a fuel-air mixture conduit (77) for keeping a catalytic converter at a given temperature.
